(19) United States
(12) Patent Application Publication
(10) Pub. No.: US 2005/0198880 A1
(43) Pub. Date: Sep. 15, 2005

(54) Freeze and heat food preportioning bag

(76) Inventors: Robert McLellan, El Paso, TX (US); Ricki Combs, El Paso, TX (US); Alfred Diaz, El Paso, TX (US)

Correspondence Address: R. Blake Johnston;PIPER RUDNICK LLP, P.O. Box 64807, Chicago, IL, 60664-0807, US

(21) Appl. No.: 10/796,725

(22) Filed: Mar. 9, 2004

(51) Int. Cl. G09F 23/00

(52) U.S. Cl. 40/637

(57) ABSTRACT

A preportioning bag used in food operations where a bulk food supply is divided into portions of smaller size, individual portions are located in a bag, and the bag is stored for use at a later date. The bag includes a front wall and a back wall that are joined so that a main body having closed side and bottom edges is defined. Multiple vents in the form of semi-circular slits are formed in the front and back walls of the bag. The front and back walls are constructed of a material that will withstand freezing and heating by microwave or steam. The bag features a day of the week printed thereon and is color-coded accordingly. A set of the bags may be mounted on a saddle structure.

### BACKGROUND OF THE INVENTION

This invention relates to food preportioning bags of the type used in food handling facilities such as restaurants and, in particular, to a food preportioning bag that, when filled, may be frozen and heated.

In a typical situation, restaurants or the like receive food such as vegetables, shrimp or chicken in bulk form. In off-peak hours, employees divide the food into individual portions so that when the restaurant is busy, there will be no time wasted preparing such portions.

It has become a common practice to store the individual portions in separate plastic bags to preserve freshness and for ease of handling. Since it was recognized that the preparation of the bulk food and the preportioning thereof might occur on a different day through the use thereof, a system needed to be developed which would insure that the oldest product in storage was used first. Since it was seldom, if ever, desirable to use such food more than one week after storage, such systems evolved into simply indicating the day on which the portioning took place or by which the food must be used. “Tuesday” food in storage would then be used before “Wednesday” food, etc.

Marking pens could be utilized to write the day on the bags but this method is unreliable due to erasure or smudging, and the method is also time consuming. Adhesive labels, each having a separate day printed thereon, became a more acceptable practice. Such labels were also color coded so that workers would be able to recognize a “Wednesday” label by its red color; a “Thursday” label by its brown color, etc. This facilitated selection of the correct day label from the inventory of labels for application to the bags of preportioned food, and it also facilitated selection of the bags from storage on or before the “use by” day.

The application of the adhesive labels still added time to the preportioning operation which is a problem recognized in U.S. Pat. No. 5,642,605 to Termer et al. The plastic bags disclosed therein each have a separate day of the week printed thereon, the printing preferably being in the same separate colors that were used on the adhesive labels. With these bags, it was only necessary to select from the inventory of bags those marked with the day that the preportioning is taking place or the “use by” day. This eliminated the time needed for applying a label to each bag.

The bagged individual food portions are often frozen during storage and must be heated prior to use. As a result, the use of preportioning bags is made even more convenient if the food preportioning bags may be frozen and heated in a microwave and/or steamed. Such a bag would streamline the process of preparing the food in the bag for serving or other use in that the bag could simply be removed from freezer storage and heated without removing the food from the bag. The prior art has failed to disclose a food preportioning bag that provides such freezer to microwave or steamer to plate capability.

### SUMMARY OF THE INVENTION

This invention relates to food preportioning bags which enable still further efficiencies in the portioning, storage and preparation of food initially in bulk form. In accordance with the invention, at least seven sets of bags are provided. The bags are printed with day identification indicia in multiple languages. In addition, the bags are color-coded to reflect the day imprinted on the bags. As a result, the bags may be easily identified for use. A set of clear bags is also provided and each bag of the set features a blank instead of day identification indicia so that specific dates may be marked on the bags.

The bags are constructed from a material that will withstand freezing, microwave heating and steaming. The bags also are provided with vents. As a result, the food within the bags may be frozen and heated without removal from the bags. The bags may be mounted on a “saddle” for ease of use.

For a more complete understanding of the nature and scope of the invention, reference may now be had to the following detailed description of embodiments thereof taken in conjunction with the appended claims and accompanying drawings.

### BRIEF DESCRIPTION OF THE DRAWINGS

FIG. 1 is perspective view of an embodiment of the bags of the invention shown in assembled relationship on a saddle structure;

FIG. 2 is a plan view of the front of one of the bags of FIG. 1; and

FIG. 3 is a plan view of the back of the bag of FIG. 2.

### DESCRIPTION OF THE PREFERRED EMBODIMENTS

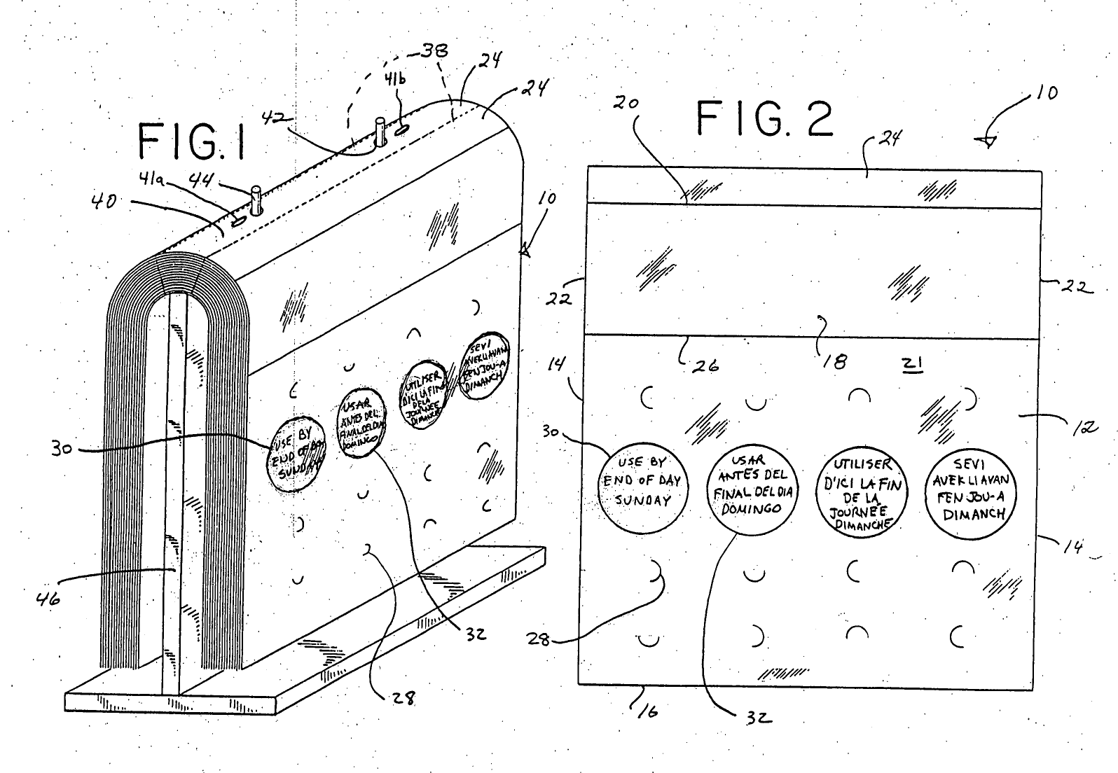

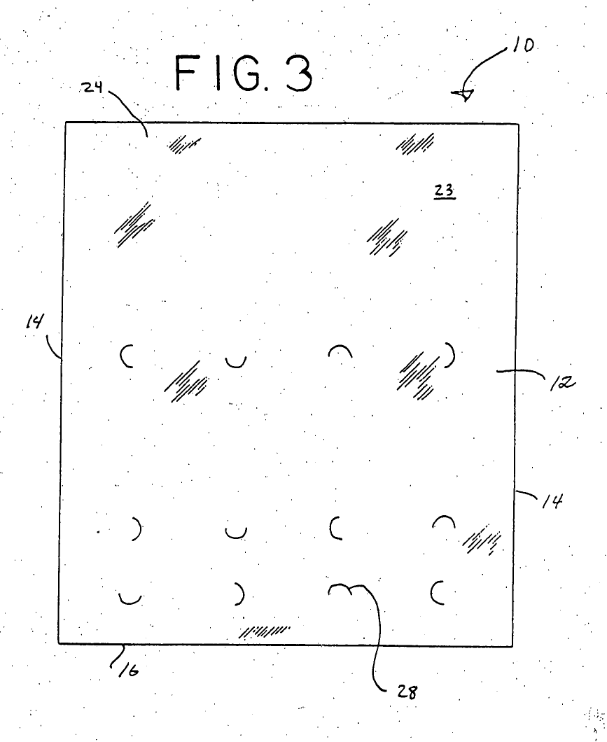

The drawings illustrate a preportioning bag 10 having a main body portion 12 with closed side edges 14 and a closed bottom edge 16. With reference to FIG. 2, a front overlay 18 may be folded along the edge 20 into overlying relationship with the front wall 21 of the main body portion and secured at its sides 22 by heat sealing to the main body portion. The back wall of the main body portion, illustrated at 23 in FIG. 3, includes an extension 24 which may be tucked within the bag after filling. The free edge 26 of the overlay 18 is then pulled over the open top of the bag to form a closure. It is to be understood, however, that the bag 10 could use a different sealing method. For example, the bag could use a zipper type locking seal located near the tops of the front wall 21 and back wall 23.

Preportioning bag 10 is constructed of a plastic material that will withstand freezing, microwave heating and steaming. High Molecular Weight-High Density Polyethylene is the preferred material. In addition, as indicated at 28, the front wall 21 and rear wall 23 of the bag are provided with vents 28. These vents preferably consist of multiple semi-circular slits cut into the front and rear walls of the bag. While semi-circular slits are illustrated, the shape and number of the slits may vary. The vents permit vapor to escape the bag during heating so that the pressure within the bag does not rise to an excessive level. As a result, the preportioning bags of the invention may be used to store and prepare food so that it is travels in the bags directly from the freezer to the microwave or steamer to the plate or other use.

As illustrated in FIGS. 1 and 2, the bags of this invention have the text “Use by End of Day XXXX” printed thereon, where XXXX is one of the seven days of the week, as shown at 30. Separate printed blocks 32 are provided for the text in foreign languages such as French, Spanish and Haitian Creole. While the set of bags illustrated in FIGS. 1 and 2 indicate “Sunday” as the day of the week, at least six other sets of bags are preferably provided for a total of seven sets of bags. As a result, each day of the week has a dedicated set of bags that are marked with that day's name, and the accompanying text, in English, French, Spanish and Haitian Creole. It is to be understood that additional or alternative foreign languages may be provided on each bag. In addition, identification indicia other than a day of the week may be preprinted on the bags.

The bags of a set are all of one color. The bag sets are preferably color-coded to the seven days of the week with the selected colors following conventional practice as follows:

| | |
|---|---|
| Sunday - | Black |
| Monday - | Blue |
| Tuesday - | Yellow |
| Wednesday - | Red |
| Thursday - | Brown |
| Friday - | Green |
| Saturday - | Orange |

In addition, a clear set of bags may be provided (for a total of eight sets of bags) with blanks where the day of the week appears in FIGS. 1 and 2 so that a specific date, as opposed to a day of the week, may be marked on the bag with a marker.

In one form of the practice of the invention, a set of bags are manufactured in the form shown in FIG. 1. Specifically, the extension 24 of each bag is attached along a perforated line 38 to a central plastic strip 40. A pair of heat welds 41a and 41b, that are formed using standard heat welding techniques known in the industry, secure the set of bags together via the strip 40. In addition, the strip 40 defines openings 42 which receive pegs 44 of saddle structure 46. As illustrated, a bag 10 is releasably attached to each side edge of the strip 40 so that the bags are accessible on both sides of the saddle structure.

During a preportioning operation, workers will fill an appropriately-marked bag while on the saddle and then tear the bag off. Alternatively, workers will simply tear a bag away from the saddle structure and fill it with the desired portion. If the clear bag is used, that is, the bag that features blanks where the day is in FIGS. 1 and 2, the day by which the food should be used may be marked in any desirable fashion.

It will be understood that various changes and additions may be made in the subject matter of the invention without departing from the spirit of the invention particularly as defined in the following claims.

1. A preportioning bag used in food operations where a bulk food supply is divided into portions of smaller size, individual portions are located in a bag, and the bag is stored for use at a later date, comprising:
a. a front wall;
b. a back wall;
c. said front wall and back wall joined so that a main body having closed side and bottom edges is defined, said main body having identification indicia including a single day of the week printed thereon;
d. at least one vent formed in said main body; and
e. said front and back walls constructed of a material that will withstand freezing and heating.

2. The preportioning bag of claim 1 wherein the material of the front and back walls is High Molecular Weight-High Density Polyethylene.

3. The preportioning bag of claim 1 wherein the at least one vent is a slit.

4. The preportioning bag of claim 3 wherein the slit is semi-circular.

5. The preportioning bag of claim 1 wherein there are a plurality of vents that are formed in the front and back walls.

6. (canceled)

7. (canceled)

8. The preportioning bag of claim 1 wherein the day of the week is printed in at least two languages.

9. The preportioning bag of claim 1 wherein the main body is color-coded to the day of the week printed thereon.

10. The preportioning bag of claim 1 wherein the identification indicia includes a blank for marking information.

11. The preportioning bag of claim 1 further comprising a central plastic strip connected to the main body by a perforated line.

12. The preportioning bag of claim 11 wherein the central plastic strip includes an opening adapted to receive a peg of a saddle structure.

13. A system used in food operations where a bulk food supply is divided into portions of smaller size, individual portions are located in a bag, and the bag is stored for use at a later date, comprising:
a. a plurality of preportioning bags, each bag including:
i) a front wall;
ii) a back wall;
iii) said front wall and back wall joined so that a main body having closed side and bottom edges is defined, said main body marked with a single day of the week and color-coded to that day of the week;
iv) at least one vent formed in said main body; and
v) said front and back walls constructed of a material that will withstand freezing and heating;
b. a saddle structure supporting the plurality of preportioning bags.

14. The system of claim 13 further comprising a central plastic strip to which the plurality of preportioning bags are joined by perforated lines, said central plastic strip resting on the saddle structure so that the preportioning bags are mounted thereon.

15. The system of claim 14 wherein the saddle structure includes a peg and the central plastic strip includes an opening that engages the peg of the saddle structure.

16. The system of claim 13 wherein the material of the front and back walls is High Molecular Weight-High Density Polyethylene.

17. (canceled)

18. A method of storing and preparing food comprising the steps of:
a. receiving a bulk food supply;
b. dividing the bulk food supply into individual food portions;
c. providing preportioning bags constructed with at least one vent and of a material that will withstand freezing and heating, said proportioning bags each marked with an individual day of the week;
d. filling the preportioning bags with the individual food portions based on the day of the week marked on the bags;
e. freezing the filled preportioning bags; and
f. heating the filled preportioning bags for serving.

19. The method of claim 18 wherein the filled preportioning bags are heated by microwave.

20. The method of claim 18 wherein the filled preportioning bags are heated by steam.
